(19) United States
(12) Patent Application Publication
(10) Pub. No.: US 2011/0018651 A1
(43) Pub. Date: Jan. 27, 2011

(54) POWER COMBINER AND MICROWAVE INTRODUCTION MECHANISM

(75) Inventors: Taro Ikeda, Yamanashi (JP); Shigeru Kasai, Yamanashi (JP)

Correspondence Address: CANTOR COLBURN LLP, 20 Church Street, 22nd Floor, Hartford, CT, 06103, US

(73) Assignee: TOKYO ELECTRON LIMITED, Tokyo (JP)

(21) Appl. No.: 12/922,702

(22) PCT Filed: Mar. 9, 2009
(86) PCT No.: PCT/JP2009/054387

§ 371 Date: Sep. 15, 2010

(30) Foreign Application Priority Data
Mar. 19, 2008 (JP) 2008-072192

(51) Int. Cl. H01P 5/18

(52) U.S. Cl. 333/118

(57) ABSTRACT

A power combiner 100 comprises a tubular main container 1, a plurality of power introduction ports 2 provided on the lateral surface of the main container 1 and introducing power as electromagnetic waves, a plurality of feeding antennas 6 provided, respectively, on plurality of power introduction ports 2, a combiner part 10 performing spatial combining of electromagnetic waves radiated from the plurality of feeding antennas 6 into main container 1, and an output port 11 for outputting electromagnetic waves combined at combiner part 10. Each feeding antenna 6 consists of an antenna main body 23 having a first pole 21 to which electromagnetic waves are supplied from a power introduction port 2 and a second pole 22 for radiating the electromagnetic waves thus supplied, and a reflection part 24 so provided as to project sideways from antenna main body 23 and reflecting electromagnetic waves.

### FIELD OF INVENTION

The present invention relates to a power combiner and a microwave introduction mechanism using the same.

### BACKGROUND OF THE INVENTION

In a manufacturing process of a semiconductor device or a liquid crystal display device, a plasma processing apparatus such as a plasma etching apparatus and a plasma CVD film forming apparatus has been employed to perform a plasma process, such as an etching process or a film forming process, on a substrate to be processed such as a semiconductor wafer and a glass substrate

Recently, as such a plasma processing apparatus, a microwave plasma processing apparatus is attracting attention using microwave plasma which can perform a plasma process with less damages by plasma having high density and low electron temperature.

As for a microwave plasma processing apparatus, it is known that a process gas is turned into a plasma by supplying a microwave generated in a microwave generating apparatus to an antenna having slots arranged in a chamber through a waveguide/coaxial tube, and radiating the microwave from the slots of the antenna to a processing space in the chamber.

However, since such a microwave plasma apparatus needs a relatively large electric power, there is a concern that microwave power source may become larger and a large current may flow at a power supply unit, when the power is supplied by a single power source.

In order to prevent such things, a power combining technique may be considered which combine the supplied power and make the thus-obtained power larger. A power combiner technique using the conventional ┌Wilkinson combiner┘ is known as such power combiner technique.

However, since the Wilkinson combiner includes a reflection absorption resister therein and the technique is a “direct supply type” (supply power to power), it is likely to cause a power loss and generate heat. Accordingly there is a problem that an effective transmission power decreases. Especially, when the shape of the power supply is small and the size of each part is small, the resistance increases because of the small size and the tendency to cause the above problem increases. Further, it is required to combine the power with a simple method.

### SUMMARY OF THE INVENTION

An object of the present invention is not to cause the heat problem accompanied by the power loss and to provide a power combiner which can combine the power with a simple method. Another object of the present invention is to provide a microwave introduction mechanism using such power combiner.

According to the first aspect of the present invention, a power combiner is provided including a main container having a tubular shape, a plurality of power introduction ports provided on the lateral surface of the main container and each configured to introduce the power as an electromagnetic wave, a plurality of feeding antennas provided on each of the plurality of power introduction ports and each configured to radiate the supplied electromagnetic wave into the main container, a combiner part configured to perform a spatial combining of electromagnetic waves radiated from the plurality of feeding antennas into the main container, and an output port configured to output the electromagnetic waves combined at the combiner part. Each of the plurality of feeding antennas includes an antenna main body having a first pole to which the electromagnetic waves are supplied from the power introduction port and a second pole that radiates the supplied electromagnetic wave, and a reflection part provided so as to protrude along the side direction of the antenna main body and configured to reflect the electromagnetic wave. The feeding antenna is configured to form a standing wave with an incident wave on the antenna main body and a reflected wave on the reflection part, and the electromagnetic wave of the standing wave radiated from each of the plurality of feeding antennas is combined in the combiner part.

According to the second aspect of the present invention, a microwave introduction apparatus is provided utilized for a microwave plasma source for forming a microwave plasma in a chamber. The microwave introduction apparatus includes a main container having a tubular shape, a plurality of microwave power introduction ports provided on the lateral surface of the main container and configured to introduce the microwave power as microwaves of electromagnetic waves, a plurality of feeding antennas provided on each of the plurality of microwave power introduction ports configured to radiate the supplied microwaves into the main container, a combiner part configured to perform a spatial combining of the microwaves radiated from the plurality of feeding antennas into the main container, and an antenna part that includes a microwave radiation antenna for radiating the microwaves combined in the combiner part into the chamber. The feeding antenna includes an antenna main body having a first pole to which the microwaves are supplied from the microwave power introduction port and a second pole that radiates microwaves, and a reflection part provided so as to protrude in the side direction from the antenna main body and configured to reflect microwaves. The feeding antenna is configured to form standing waves with the incident microwaves on the antenna main body and the reflected microwaves on the reflection part, and the microwaves of the standing waves radiated from each of the feeding antennas are combined in the combiner part.

In the first and the second aspects, the main container further includes an inner conductor having a tubular or columnar shape provided so as to have the same axle with the main container, and it is preferable that the second pole of the antenna main body is in contact with the inner conductor. Also, it is preferable that the reflection part is provided so as to protrude in the directions of both sides from the antenna main body. Also, it is preferable that the reflection part is provided at a position which is ¼ wavelength away from the first pole of the antenna main body or within the range of −10%˜+100% with reference to the position. Also, it is preferable that the length of the refection part is ½ wavelength or within the range of −10%˜+50% with reference to the length. Also, the reflection part may preferably have a circular arc shape. Also, the feeding antenna may be formed on a printed board and composed of a micro-strip line. Also, it is preferable that the microwave introduction apparatus further includes a dielectric member provided such that the feeding antenna is interposed therebetween, and the thickness of the dielectric member may preferably be an effective length of ½ wavelength or within a range of −20%˜+20% with reference to the effective length of ½ wavelength.

In the second aspect described above, the microwave introduction apparatus may include a tuner that adjusts the impedance in the microwave transmission path and provided between the combiner part of the main container and the microwave radiation antenna. In this case, the tuner and the antenna may preferably function as a resonator. Also, the tuner may be a slug tuner having two dielectric slugs.

Also, the microwave radiation antenna may have a planar shape, and be provided with a plurality of slots. In that case, the slot may preferably have an arc shape. Also, it is preferable that the antenna part has a ceiling plate formed with a dielectric material through which the microwave radiated from the antenna is transmitted and a wave retardation member provided at an opposite side of the ceiling plate with respect to the antenna for shortening the wavelength of the microwave that reaches the antenna. In that case, the phase of the microwave may be adjusted by adjusting the thickness of the wave retardation member.

According to the present invention, a plurality of power introduction ports are provided on the lateral surface of the main container having a tubular shape in a plurality of chambers. The plurality of power introduction ports are provided with a feeding antenna that includes the antenna main body having the first pole to which electromagnetic waves are supplied from the power introduction port and the second pole for radiating the supplied electromagnetic waves, and the reflection part provided so as to protrude in the side direction from the antenna main body and reflecting electromagnetic waves. Also, the feeding antenna is configured to form a standing wave with the incident waves on the antenna main body and the reflected waves on the reflection part, and a spatial combining of the electromagnetic waves is performed at the combiner part and the electromagnetic waves are outputted from the output port. Accordingly, the margin of the power supply can be increased because a crossing point does not exist in combining the power, and the power combining is possible without a heat generating problem accompanied by the power loss. Also, the power combining process may be very simple because the feeding antenna with a predetermined structure is simply provided at the power introduction port.

Also, the microwave introduction mechanism using such power combiner can combine the microwaves to obtain a sufficient output without generating the heat problem accompanied by the power loss.

### BRIEF DESCRIPTION OF THE DRAWINGS

FIG. 1 is a vertical cross-sectional view illustrating a power combiner, according to one exemplary embodiment of the present invention.

FIG. 2 is a horizontal cross-sectional view illustrating a power introduction port of the power combiner, according to one exemplary embodiment of the present invention.

FIG. 3 is a plan view illustrating a feeding antenna which is used in the power combiner, according to one exemplary embodiment of the present invention.

FIG. 4 is a schematic diagram illustrating a state where an induced magnetic field H is formed in the power combiner, according to one exemplary embodiment of the present invention.

FIG. 5 is a schematic diagram illustrating a state where an induced electric field E and a reflected electric field R are formed in the power combiner, according to one exemplary embodiment of the present invention.

FIG. 6 is a cross-sectional view illustrating a schematic configuration of a plasma processing apparatus equipped with a microwave introduction mechanism using the power combiner, according to one exemplary embodiment of the present invention

FIG. 7 is a block diagram illustrating the configuration of the microwave plasma source as shown in FIG. 6.

FIG. 8 is a cross-sectional view illustrating the structure of the microwave introduction mechanism of the microwave plasma source as shown in FIG. 7.

FIG. 9 is a plan view illustrating a plane slot antenna equipped in the microwave introduction mechanism as shown in FIG. 8.

FIG. 10 is a schematic diagram illustrating a simulation model.

FIG. 11A is a schematic diagram illustrating the structure of a No. 1 feeding antenna used in the simulation.

FIG. 11B is a schematic diagram illustrating the structure of a No. 2 feeding antenna used in the simulation.

FIG. 11C is a schematic diagram illustrating the structure of a No. 3 feeding antenna used in the simulation.

FIG. 11D is a schematic diagram illustrating the structure of a No. 4 feeding antenna used in the simulation.

FIG. 12A depicts the size of each portion of the power combiner used in the simulation.

FIG. 12B depicts the size of the feeding antenna of the power combiner used in the simulation.

### DETAILED DESCRIPTION OF SEVERAL EMBODIMENTS

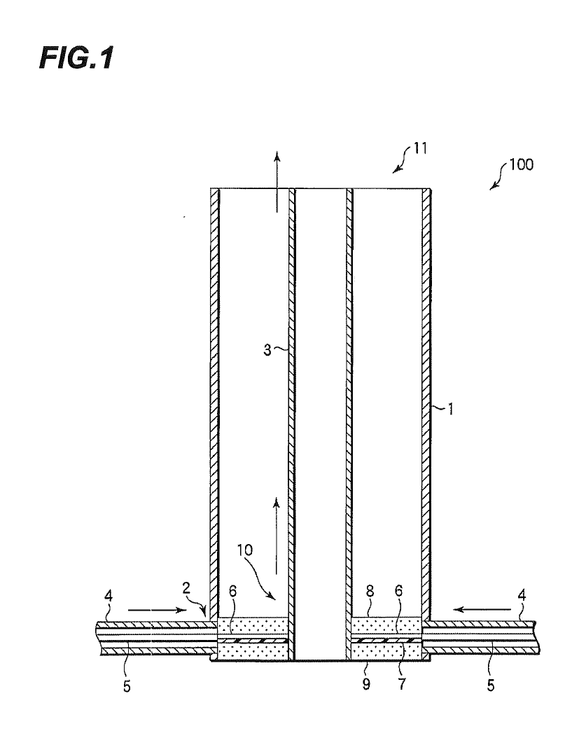

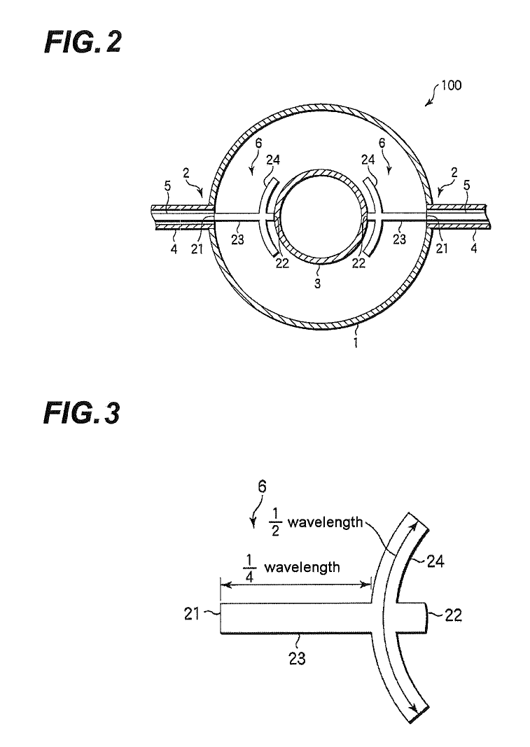

Hereinafter, embodiments of the present invention will be described with reference to the accompanied drawings. FIG. 1 is a vertical cross-sectional view illustrating a power combiner according to one exemplary embodiment of the present invention, and FIG. 2 is a horizontal cross-sectional view illustrating a power introduction port thereof. A power combiner 100 includes a main container 1 having a tubular shape and two power introduction ports 2 provided on the lateral surface of a main container 1 to introduce power as electromagnetic waves. An inner conductor 3 having a tubular shape is provided in main container 1 so as to form a concentric shape with main container 1 and constitutes a coaxial line. Also, inner conductor 3 may have a columnar shape.

A coaxial line 4 is provided in each of two power introduction ports 2. And, a feeding antenna 6 extending horizontally to the inside of main container 1 is connected to the front end of inner conductor 5 in coaxial line 4. Feeding antenna 6 is formed as a micro-strip line on a PCB board 7 which is a printed board. Feeding antenna 6 is inserted by dielectric members 8 and 9 formed with a dielectric material such as quartz which functions as a wave retardation member. Dielectric members 8 and 9 may preferably have a total thickness of an effective length of ½ wavelength to adjust the size of feeding antenna 6. Also, dielectric members 8 and 9 may have a total thickness of an effective length within a range of −20% and +20% of the effective length of ½ wavelength. That is, the total thickness of an effective length may be within a range of 3/10 and 7/10 wavelength.

The vicinity of power introduction port 2 in the inner space of main container 1 functions as a combiner part 10 performing a spatial combining of electromagnetic waves introduced from two power introduction ports 2. Then, the electromagnetic waves spatially combined at combiner part 10 propagate upward from the inside of main container 1. The upper portion of main container 1 is an output port 11 outputting the combined electromagnetic waves.

As shown in FIG. 2, feeding antenna 6 includes an antenna main body 23 connected to inner conductor 5 of coaxial line 4 at power introduction port 2 and having a first pole 21 to which electromagnetic waves are supplied and a second pole 22 radiating the supplied electromagnetic waves, and a reflection part provided so as to protrude in both sides direction from antenna main body 23 and reflecting electromagnetic waves. Feeding antenna 6 is configured to form a standing wave with the incident waves on antenna main body 23 and the reflected waves on reflection part 24. Also, the electromagnetic wave of the standing wave radiated from each of feeding antennas 6 are combined in combiner part 10 as explained above.

At power combiner 100 configured as described the above, as the electromagnetic wave propagating from coaxial line 4 reaches first pole 21 of feeding antenna 6 at power introduction port 2, the electromagnetic wave propagates along antenna main body 23, and the electromagnetic wave is radiated from second pole 22 of the front-end of antenna main body 23. Also, the electromagnetic wave propagating along antenna main body 23 is reflected at reflection part 24 and is combined with an incident wave. At this time, a standing wave is generated by adjusting the phase of the reflected wave. Specifically, as shown in FIG. 3, a maximum standing wave can be generated by placing reflection part 24 at a position which is ¼ wavelength away from first pole 21 of feeding antenna 6. Also, reflection part 24 may be placed at a position within a range of −10%˜+100% of ¼ wavelength away from first pole 21, that is a position within a range of 9/40 and 1/2 wavelength away from first pole 21.

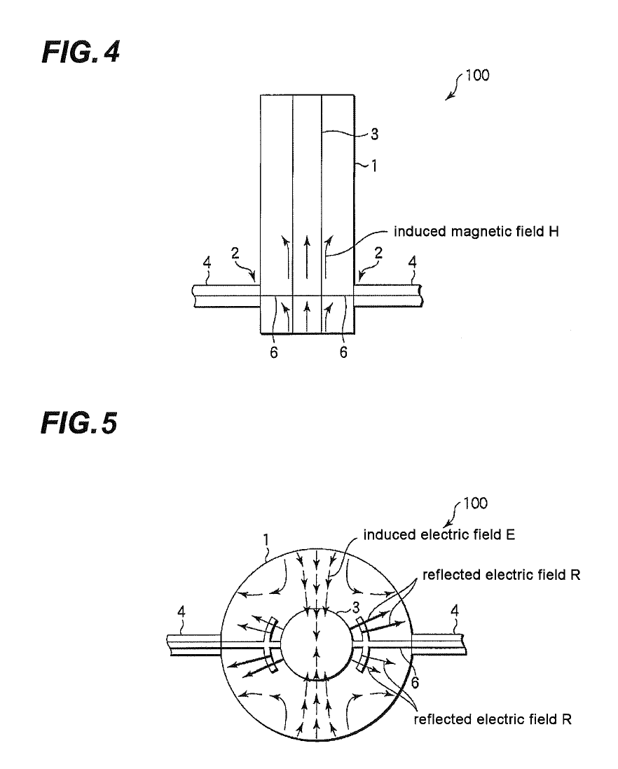

As a standing wave is generated at a placement position of feeding antenna 6, an induced magnetic field H is generated along the outer wall of inner conductor 6 as shown in FIG. 4, and an induced electric field E is generated at a position forming a 90° angle against feeding antenna 6. By such a chain action, the electromagnetic waves are combined to propagate in main container 1 and outputted from output port 11. Also, FIG. 5 depicts a reflected electric field R reflected at reflection part 24 and inner conductor 3.

In this case, the length L (refer to FIG. 3) of reflection part 24 may preferably be ½ wavelength. By this, reflection part 24 can generate a resonance as well as a standing wave. Also, the length L of reflection part 24 may be within a range of −10% and ˜50% of ½ wavelength, that is, within a range of 9/20 and ¾ wavelength. Second pole 22 of antenna main body 23 may preferably be in contact with inner conductor 3. With this, the electromagnetic wave can resonate in a wide range. Reflection part 24 has a circular arc shape according to the shape of inner conductor 3. By making reflection part 24 with a circular arc shape, the TEM wave can be generated easily.

As described above, since the power introduced as an electromagnetic wave in main container 1 from two power introduction ports 2 is spatially combined through feeding antenna 6, there is no crossing point occurred in power combining and the power can be combined without the heat generation problem. Also, by combining the power as described above, the margin of power supply can be increased as compared to the power supply from one path. Also, since installing of the feeding antenna at power introducing port 2 alone is beneficial, the power can be combined with a simple method.

Also, the shape of reflection part 24 of feeding antenna 6 may not be limited to a circular arc shape and may be other shapes such as a straight shape.

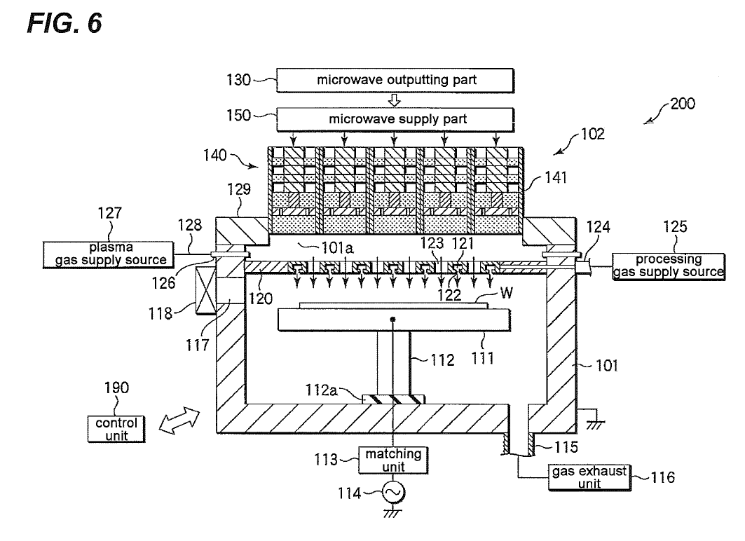

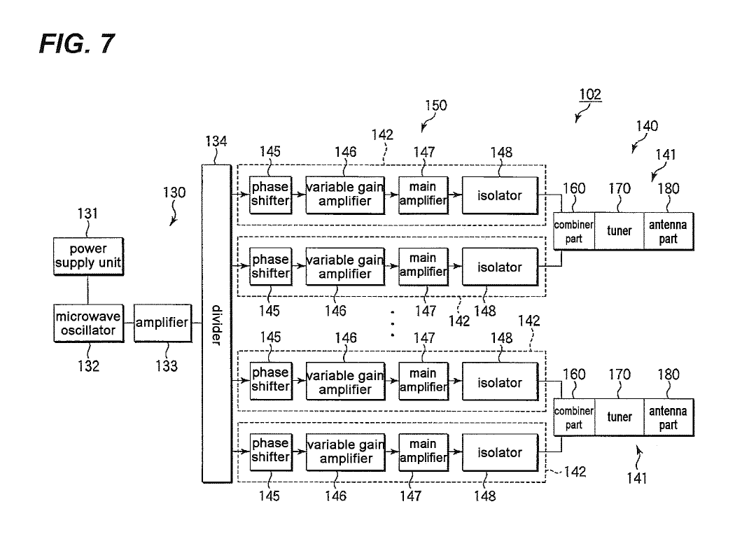

Next, an exemplary embodiment of a microwave introduction mechanism will be described in which the power combiner is applied to a plasma processing apparatus. FIG. 6 is a cross sectional view showing a schematic configuration of a plasma processing apparatus having a microwave introduction mechanism to which the power combiner according to the present invention is applied, and FIG. 7 illustrates a configuration of the microwave plasma source as shown in FIG. 6.

A plasma processing apparatus 200 is configured as a plasma etching apparatus for performing a plasma processing, such as an etching, on a wafer, and includes an approximately cylindrical chamber 101 that is grounded and made of a metal material such as airtight aluminum or stainless steel, and a microwave plasma source 102 for forming a microwave plasma in chamber 101. An opening 101a is formed at an upper portion of chamber 101, and microwave plasma source 102 is installed toward the interior of chamber 101 from opening 101a.

A susceptor 111 is provided in chamber 101 for horizontally supporting a wafer W as a target object while being supported by a cylindrical supporting member 12 installed upwardly at the center of the bottom portion of chamber 101 via an insulating member 112a. Susceptor 111 and supporting member 112 are made of, for example, aluminum having an alumite treated (anodically oxidized) surface.

Although it is not illustrated, susceptor 111 is provided with an electrostatic chuck for electrostatically absorbing wafer W, a temperature control mechanism, a gas channel for supplying a heat transfer gas to the backside of wafer W, an elevating pin for elevating wafer W for a transfer. Further, susceptor 111 is electrically connected to a high frequency bias power supply 114 via a matching unit 113. By supplying the high frequency power from high frequency bias power supply 114 to susceptor 111, ions are attracted to wafer W.

A gas exhaust line 115 is connected to a bottom portion of chamber 101, and also is connected to a gas exhaust unit 116 having a vacuum pump. By operating gas exhaust unit 116, the interior of chamber 101 is exhausted and depressurized to a predetermined vacuum level at a high speed. Moreover, installed on a sidewall of chamber 101 are a loading/unloading port 117 for loading and unloading wafer W, and a gate valve 118 for opening and closing loading/unloading port 117.

A shower plate 120 for discharging a processing gas for plasma etching toward wafer W is horizontally installed above susceptor 111 in chamber 101. Shower plate 120 has grid-shaped gas channels 121 and a plurality of gas discharge openings 122 formed in gas channel 121. A space 123 is formed between grid-shaped gas channels 121. Gas channel 121 of shower plate 120 is connected to a pipe line 124 extending to the outside of chamber 101, and pipe line 124 is connected to a processing gas supply source 125.

In the mean time, a ring-shaped plasma gas introducing member 126 is provided along a chamber wall above shower plate 120 of chamber 101, and a plurality of gas discharge openings is formed on an inner periphery of plasma gas introducing member 126. Plasma gas introducing member 126 is connected to a plasma gas supply source 127 for supplying a plasma gas via a pipe line 128. As for a plasma gas, it is proper to use Ar gas.

The plasma gas introduced through plasma gas introducing member 126 into chamber 101 is turned into plasma by microwaves introduced from microwave plasma source 102 into chamber 101. The thus-generated Ar plasma passes through space 123 of shower plate 120, so that the processing gas discharged from gas discharge openings 122 of shower plate 120 is excited, and plasma of the processing gas is formed.

Microwave plasma source 102 is supported by a supporting ring 129 provided at an upper portion of chamber 101, and the gap therebetween is airtightly sealed. As illustrated in FIG. 7, microwave plasma source 102 has a microwave outputting part 130 for dividing and outputting the microwaves to a plurality of channels, a microwave introduction part 140 for guiding the microwaves to chamber 101, and a microwave supply part 150 for supplying the microwaves output from microwave outputting part 130 to microwave introduction part 140.

Microwave outputting part 130 has a power supply unit 131, a microwave oscillator 132, an amplifier 133 for amplifying the oscillated microwave, and a divider 134 for dividing the amplified microwave into a plurality of microwaves.

Microwave oscillator 132 performs, for example, PLL (Phase Locked Loop) oscillation to generate microwaves of a predetermined frequency (e.g., 2.45 GHz). Divider 134 divides the microwave amplified by amplifier 133 while matching the impedance between an input side and an output side so that the loss of the microwaves can be minimized. In addition, as for the frequency of the microwave, 8.35 GHz, 5.8 GHz, 1.98 GHz or the like may be used in addition to 2.45 GHz.

Microwave supply part 150 has a plurality of amplifier parts 142 for mainly amplifying the divided microwaves. Amplifier part 142 has a phase shifter 145, a variable gain amplifier 146, a main amplifier 147 forming a solid state amplifier, and an isolator 148.

Phase shifter 145 is configured to shift phases of the microwaves by a slug tuner, and the radiation characteristics can be modulated by adjusting phase shifter 145. For example, the plasma distribution can be changed by controlling the directivity by adjusting the phase in each of the antenna modules, and the circular polarized waves can be obtained by shifting the phase by 90° between adjacent antenna modules. When there is no need to modulate the radiation characteristics, phase shifter 145 need not be provided.

Variable gain amplifier 146 is an amplifier for adjusting the variation in the antenna modules or adjusting the plasma intensity by adjusting a power level of microwaves inputted to main amplifier 147. By changing variable gain amplifier 146 for each of the antenna modules, the generated plasma distribution can be variably controlled.

Main amplifier 147 forming the solid state amplifier may have an input matching circuit, a semiconductor amplifying device, an output matching circuit and a high Q resonant circuit.

Isolator 148 separates microwaves reflected to main amplifier 147 from microwave introduction part 140, and has a circulator and a dummy load (coaxial terminator). The circulator leads the microwave reflected by an antenna part 180 to the dummy load, and the dummy load converts the reflected microwave led by the circulator into heat.

Microwave introduction part 140 has a plurality of microwave introduction mechanisms 141 as shown in FIG. 7. Also, in each of microwave introduction mechanisms 141, the microwave power is supplied from each of two amplifier parts 142, and configured to be combined and radiated.

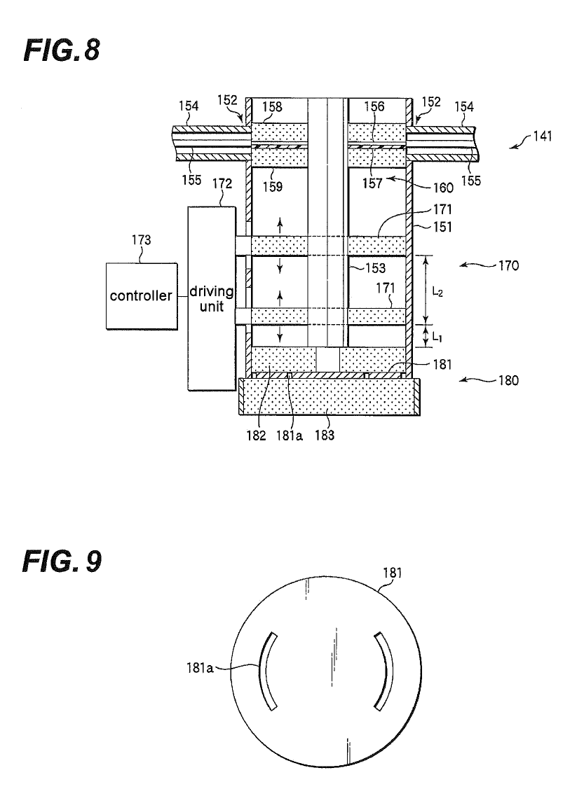

Microwave introduction mechanism 141 combines the microwave power by the power combiner having the above constitutions, radiates the combined microwave and introduces it in chamber 101. Microwave introduction mechanism 141 includes a combiner part 160, a tuner 170 and an antenna part 180 and the structure thereof is shown in FIG. 8.

Microwave introduction mechanism 141 includes a main container 151 forming a tubular shape having an inner conductor 153 therein, and main container 151 includes two microwave power introduction ports 152 for introducing the microwave power at the rear-end side surface of main container 151. Also, microwave introduction mechanism 141 includes a tuner 170 provided at the center portion of main container 151, and an antenna part 180 provided at the front-end side of main container 151.

Microwave power introduction port 152 is connected to a coaxial line 154 for supplying the microwave amplified by amplifier part 142. Also, the front-end of inner conductor 155 of coaxial line 154 is connected to a feeding antenna 156 horizontally extending to the inside of main container 151. Feeding antenna 156 is formed as a micro-strip line in a PCB board 157. Feeding antenna 156 is interposed between dielectric members 158 and 159 including dielectric materials such as quartz. Feeding antenna 156 has the same functions and constitutions as feeding antenna 6.

The vicinity of microwave power introduction port 152 in the inner space of main container 151 functions as combiner part 160 performing the spatial combining of the electromagnetic waves introduced from two microwave power introduction ports 152. Then, the electromagnetic waves that are spatially combined at combiner part 160 propagate toward the front-end of antenna part 180 inside main container 151.

Antenna part 180 has a plane slot antenna 181 which functions as a microwave radiation antenna. Plane slot antenna 181 forms a plane and is provided with slots 181a, and inner conductor is connected to plane slot antenna 181. Antenna part 180 has a wave retardation member 182 provided on the top surface of plane slot antenna 181. Wave retardation member 182 has a dielectric constant larger than that of vacuum, and is made of polyimide-based resin or fluorine-based resin, for example, quartz, ceramic, poly tetrafluoroethylene. Since the wavelength of the microwave is lengthened in the vacuum, wave retardation member 182 has a function of shortening the wavelength of the microwave, thereby controlling the plasma. Wave retardation member 182 can adjust the phases of the microwaves by its thickness, and the thickness is adjusted so that plane slot antenna 181 becomes an antinode of the standing wave. Accordingly, the radiation energy of the plane slot antenna can be maximized while minimizing the reflection.

Further, a ceiling plate 183 made of a dielectric member such as quartz or ceramics is provided at the further front-end side of plane slot antenna 181 for a vacuum sealing. Further, the microwaves amplified by main amplifier 147 pass through the gap between the circumference wall of inner conductor 153 and main container 151, and are radiated into chamber 101 after being transmitted through ceiling plate 183 via slots 181a of plane slot antenna 181. At this time, as shown in FIG. 9, slots 181a are preferably formed in an arc shape, and the number thereof is preferably two as illustrated, or four. Accordingly, the microwave can be effectively transmitted in a TE mode.

Tuner 173 has two slugs 171 positioned between combiner part 160 and antenna part 180 of main container 151, and forms a slug tuner. Slugs 171 are formed as dielectric plate-shaped members, and are disposed in a round ring shape between the outer wall of inner conductor 153 and main container 151. Further, the impedance is adjusted by vertically moving slugs 171 by driving unit 172 based on the instruction from controller 173. Controller 173 adjusts the impedance of termination to be, e.g., about 50Ω. When only one of the two slugs moves, a path that passes through the origin of the smith chart is drawn. In contrast, when both of the slugs move simultaneously, only the phase rotates.

In the present embodiment, main amplifier 147, tuner 143, and plane slot antenna 181 are arranged to be located close to one another. Further, tuner 170 and plane slot antenna 181 form a lumped constant circuit within ½ wavelength, and also serve as a resonator.

Each unit of plasma processing apparatus 200 is controlled by a control unit 190 having a micro processor. Control unit 190 has, for example, a storage unit which stores process recipes, an input unit, and a display, and controls the plasma processing apparatus based on a selected recipe.

Hereinafter, the operation of plasma processing apparatus 200 configured as described above will be explained. First of all, wafer W is carried into chamber 101, and mounted on susceptor 111. Next, a plasma gas, e.g., Ar gas, is introduced from plasma gas supply source 127 into chamber 101 via pipe line 128 and plasma gas introducing member 126. At the same time, the microwave is introduced from microwave plasma source 102 into chamber 101, thereby forming the plasma.

Thereafter, a processing gas, for example, an etching gas such as Cl₂ gas, is discharged from processing gas supply source 125 into chamber 101 via pipe line 124 and shower plate 120. The discharged processing gas is excited by the plasma that has passed through space 123 of shower plate 120 to thereby be turned into a plasma. The thus-generated plasma of the processing gas is used to perform plasma processing, such as an etching process, on wafer W.

In this case, in microwave plasma source 102, the microwave oscillated by microwave oscillator 132 of microwave outputting part 130 is amplified by amplifier 133, and is divided into a plurality of microwaves by divider 134. The divided microwaves are guided to microwave introduction part 140 via microwave supply part 150.

The microwave power is supplied from two amplifier parts 142 of microwave supply part 150 to one microwave introduction mechanism 141 in order to establish a sufficient power at each of microwave introduction mechanisms 141 constituting microwave introduction part 140. Accordingly, microwave introduction mechanism 141 functions as a power combiner.

In this case, when the conventional method is adapted in which the combination is performed from two amplifier parts 142 through the coaxial line, a crossing point of the coaxial line is sure to be formed, and a heat generation problem occurs at the crossing point. However, in the present embodiment, power combiner 100 as described above is applied to microwave introduction mechanism 141, and coaxial line 154 of two amplifier part 142 is connected to feeding antenna 156 at each of microwave introduction ports 152 provided in main container 151. And then, the microwave is radiated from each feeding antenna 156 and the microwave power is spatially combined. As a result, there is no such heat generating problem. Also, since it is advantageous to simply connect feeding antenna 156 to each coaxial line 154 at microwave introduction port 152, the power can be combined with a very easy method.

Also, a large size isolator or a combiner is not necessary since a plurality of distributed microwaves is amplified individually with main amplifier 147 constituting a solid state amplifier, and radiated individually by plane slot antenna 181, and then combined in chamber 101.

Also, microwave introduction mechanism 141 is very compact since the structure is such that antenna part 180 and tuner 170 are provided in main container 151. Accordingly, microwave plasma source 102 can be noticeably compact. Also, main amplifier 147, tuner 170 and plane slot antenna 181 are provided closely each other, and especially, tuner 170 and plane slot antenna 181 constitute a lumped constant circuit and function as a resonator. Accordingly, a high-precision tuning is possible by tuner 170 at an attached portion of plane slot antenna 181 where the impedance is mismatched.

Also, a lumped constant circuit is formed by providing tuner 170 and plane slot antenna 181 being closely and working as a resonator, the impedance mismatching up to plane slot antenna 181 can be resolved with a high precision. Also, since the mismatching portion can practically be a plasma space, a high-precision plasma control is possible by tuner 170.

Also, since the direction of microwave can be controlled by changing the phase of each antenna module with a phase shifter, the adjustment of the distribution of plasma or the like can be readily performed.

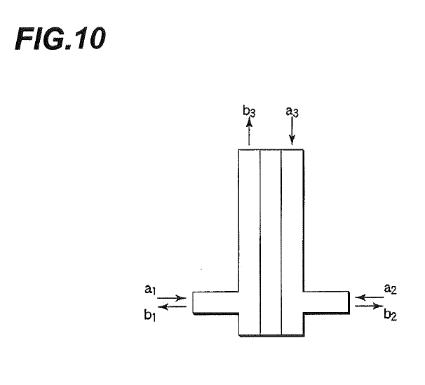

Next, the simulation result for optimizing the power combiner according to the present invention will be described. The simulation has been performed using an electromagnetic wave analysis with a finite element method. The optimization has been performed by a pseudo Newton method using S parameter. Specifically, as illustrated in FIG. 10, the following equations 1 through 3 are established assuming that a₁, a₂ are the amplitudes of electromagnetic waves propagating from each of the two power introduction ports (a first port and a second port) toward an input direction, and b₁, b₂ are the amplitudes of electromagnetic waves propagating toward the output direction. Further, it is assumed that a₃ is an amplitude of an electromagnetic wave propagating from the output port (a third port) toward the input direction, and b₃ is an amplitude of an electromagnetic wave propagating toward the output direction.

b₁=S₁₁a₃+S₁₂a₂+S₁₃a₃ (1)

b₂=S₂₁a₁+S₂₂a₂+S₂₃a₃ (2)

b₃=S₃₁a₁+S₃₂a₂+S₃₃a₃ (3)

Those equations can be transferred to a matrix form as shown below in equation 4.

$$\begin{matrix}[ mathematical equation 1 ] . & \\ ( \begin{matrix}{b}_{1} \\ {b}_{2} \\ {b}_{3}\end{matrix} ) = ( \begin{matrix}{S}_{11} & {S}_{12} & {S}_{13} \\ {S}_{21} & {S}_{22} & {S}_{23} \\ {S}_{31} & {S}_{32} & {S}_{33}\end{matrix} ) ( \begin{matrix}{a}_{1} \\ {a}_{2} \\ {a}_{3}\end{matrix} ) & ( 4 )\end{matrix}$$

The matrix having S₁₁ . . . S₃₃ as elements is a scattering matrix, and each element is a S parameter. Here, ‘m’ in Sₘₙ indicates a signal of the output port and ‘n’ in Sₘₙ indicates a signal of the input port. For example, S₃₁ is a signal that passes at the third port when a signal is inputted at the first port, and S₃₂ is a signal that passes at the third port when a signal is inputted at the second port. The following equation must be established in order to combine the power input from the first and the second ports of the power introduction ports, and output the power from the third port of the output port most effectively.

|S₃₁|²+|S₃₂|²=1.0 (5)

Since a maximum value becomes 0.70 if |S₃₁| equals to |S₃₂|, a condition has been obtained by the simulation where |S₃₁| becomes close to 0.7. Also, since |S₁₁+S₁₂| and |S₂₁+S₂₂| are not output from the third port, these values are preferably small.

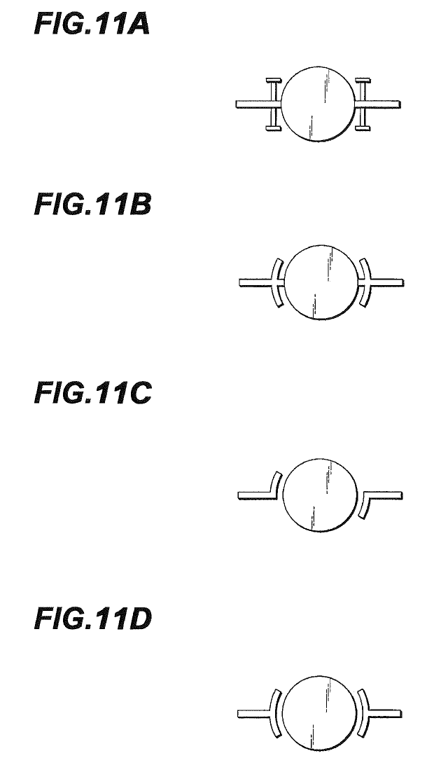

Table 1 shows the values of |S₃₁| and |S₁₁+S₁₂|, a transmission efficiency of the combined power, and, further, a reflection loss when using four kinds of feeding antennas of No. 1 through 4 as shown in FIGS. 11A through 11D. No. 1 feeding antenna includes a reflection part which extends along both sides of an antenna main body and has a straight shape. Also, a circular member is provided on both side ends of the reflection part, and the front-end of the antenna main body is in contact with the inner conductor. As shown in FIG. 2, No. 2 feeding antenna includes a reflection part which extend along both sides of the antenna main body with a circular arc shape, and the front-end of the antenna main body is in contact with the inner conductor. No. 3 feeding antenna includes a reflection part which extends along the one side of the antenna main body with a circular arc shape, and the front-end of the antenna main body is not in contact with the inner conductor. No. 4 feeding antenna includes a reflection part which extends along both sides of the antenna main body with a circular arc shape, and the front-end of the antenna main body is not in contact with the inner conductor.

TABLE 1

| | No. 1 | No. 2 | No. 3 | No. 4 |
|---|---|---|---|---|
| \|S₃₁\| | 0.70 | 0.69 | 0.29 | 0.33 |
| \|S₁₁ + S₁₂\| | 0.14 | 0.20 | 0.91 | 0.90 |
| Transmission | 98.3 | 96.1 | 16.8 | 21.8 |
| Efficiency (%) | | | | |
| Reflection Loss (%) | 1.9 | 4.1 | 82.9 | 80.2 |

From Table 1, it can be found that a good result is obtained from No. 1 and 2 feeding antenna where the reflection part extends along both sides of the antenna main body and the front-end of the antenna main body is in contact with the inner conductor. Although No. 1 feeding antenna has a better result value among No. 1 and 2 feeding antennas, No. 2 feeding antenna is better considering the convenience in manufacturing the feeding antenna.

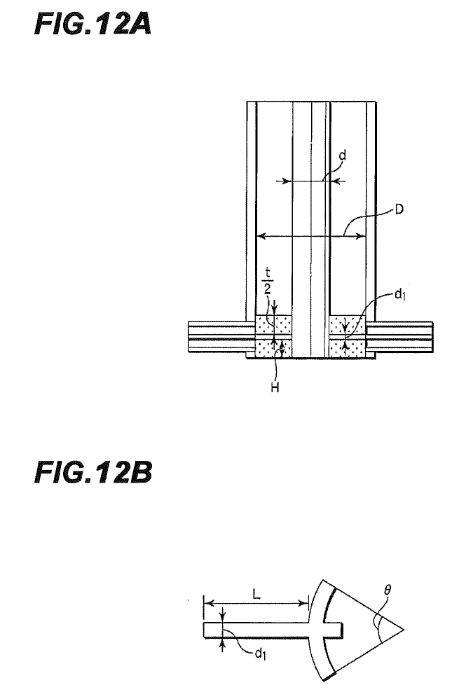

Also, other parameters have been optimized in this simulation. In case of No. 2 power combiner, it is assumed that the inner diameter D of the main container is 45 mm, the outer diameter d of the inner conductor is 20 mm, the thickness t of the dielectric member (quartz), which functions as a wave retardation plate, is 37 mm (the thickness of one dielectric member t/2), the diameter d1 of the feeding antenna is 2.55 mm, the height of the feeding antenna is the half of the thickness of the dielectric member, the location of the reflection part (the length from the rear-end portion of the antenna main body) is 35.5 mm, the angle θ of the reflection part is 56.2°, as shown in FIGS. 12A and 12B.

Also, the present invention is not limited to the above embodiments, and various modifications may be made within the scope and spirit of the present invention. For example, although the above embodiments illustrate two power introduction ports, the present invention is not limited to this. Also, although the above embodiments illustrate that the power combiner is applied to the microwave introduction mechanism used in the microwave plasma source for forming the microwave plasma in the chamber, the present invention is not limited to this and may be applied in general to any case that requires a spatial combining of the power supplied as a microwave.

What is claimed is:

1. A power combiner comprising:
a main container having a tubular shape;
a plurality of power introduction ports provided on the lateral surface of the main container and configured to introduce the power as an electromagnetic wave;
a plurality of feeding antennas provided on each of the plurality of power introduction ports and each configured to radiate the supplied electromagnetic wave into the main container;
a combiner part configured to perform a spatial combining of electromagnetic waves radiated from the plurality of feeding antennas into the main container, and
an output port configured to output the electromagnetic waves combined at the combiner part,
wherein each of the plurality of feeding antennas comprises:
an antenna main body having a first pole to which the electromagnetic wave is supplied from the power introduction port and a second pole that radiates the supplied electromagnetic wave; and
a reflection part provided so as to protrude along the side direction of the antenna main body and configured to reflect the electromagnetic wave, and
wherein each of the plurality feeding antennas is configured to form a standing wave with an incident wave on the antenna main body and a reflected wave on the reflection part, and
wherein the electromagnetic wave of the standing wave radiated from each of the plurality of feeding antennas is combined in the combiner part.

2. The power combiner according to claim 1, wherein the main container further comprises an inner conductor having a tubular or columnar shape and provided so as to have the same axle with the main container, and the second pole of the antenna main body is in contact with the inner conductor.

3. The power combiner according to claim 1, wherein the reflection part is provided so as to protrude along both sides of the antenna main body.

4. The power combiner according to claim 1, wherein the reflection part is provided at a position which is ¼ wavelength away or within a range of −10% and +100% of ¼ wavelength away from the first pole of the antenna main body.

5. The power combiner according to claim 1, wherein the length of the refection part is ½ of wavelength or within a range of −10% and +50% of the ½ of wavelength.

6. The power combiner according to claim 1, wherein the reflection part is formed with a circular arc shape.

7. The power combiner according to claim 1, wherein each of the plurality of feeding antennas is formed on a printed board and forms a micro-strip line.

8. The power combiner according to claim 1, further comprising a dielectric member provided such that each of the plurality of feeding antennas is interposed therebetween.

9. The power combiner according to claim 8, wherein the thickness of the dielectric member is an effective length of ½ wavelength or an effective length within a range of −20% and +20% of the effective length of ½ wavelength.

10. A microwave introduction apparatus being utilized for a microwave plasma source for forming a microwave plasma in a chamber, comprising:
a main container having a tubular shape;
a plurality of microwave power introduction ports provided on the lateral surface of the main container and introducing microwave power as a microwave of an electromagnetic wave;
a plurality of feeding antennas provided in each of the plurality of microwave power introduction ports and each configured to radiate the supplied microwave into the main container;
a combiner part configured to perform a spatial combining of microwaves radiated from the plurality of feeding antennas into the main container, and
an antenna part including a microwave radiation antenna configured to radiate the microwaves combined in the combiner part into the chamber,
wherein each of the plurality of feeding antennas comprises:
an antenna main body having a first pole to which the microwaves are supplied from the microwave power introduction port and a second pole configured to radiate the microwaves; and
a reflection part provided so as to protrude in the side direction from the antenna main body and reflecting microwaves, and
wherein each of the plurality of feeding antennas is configured to form a standing wave with an incident microwave on the antenna main body and a reflected microwave on the reflection part, and
wherein the microwave of the standing wave radiated from each of the plurality of feeding antennas is combined in the combiner part.

11. The microwave introduction apparatus according to claim 10, wherein the main container further comprises an inner conductor having a tubular or columnar shape and provided so as to have the same axle with the main container, and the second pole of the antenna main body is in contact with the inner conductor.

12. The microwave introduction apparatus according to claim 10, wherein the reflection part is provided so as to protrude along both sides from the antenna main body.

13. The microwave introduction apparatus according to claim 10, wherein the reflection part is provided at a position which is ¼ wavelength away from the first pole of the antenna main body or within a range of −10% and +100% of the ¼ wavelength away from the first pole of the antenna main body.

14. The microwave introduction apparatus according to claim 10, wherein the length of the refection part is ½ of wavelength or within a range of −10% and +50% of the ½ of the wavelength.

15. The microwave introduction apparatus according to claim 10, wherein the reflection part forms a circular arc shape.

16. The microwave introduction apparatus according to claim 10, wherein the feeding antenna is formed on a printed board and forms a micro-strip line.

17. The microwave introduction apparatus according to claim 10, further comprising a dielectric member provided such that the feeding antenna is interposed therebetween.

18. The microwave introduction apparatus according to claim 17, wherein the thickness of the dielectric member is an effective length of ½ wavelength or an effective length within a range of −20% and +20% of the effective length of ½ wavelength.

19. The microwave introduction apparatus according to claim 10, further comprising a tuner for adjusting impedance in a microwave transmission path and provided in between the combiner part of the main container and the microwave radiation antenna.

20. The microwave introduction apparatus according to claim 19, wherein the tuner and the antenna function as a resonator.

21. The microwave introduction apparatus according to claim 19, wherein the tuner is a slug tuner comprising two dielectric slug.

22. The microwave introduction apparatus according to claim 10, wherein the microwave radiation antenna has a planar shape, and is provided with a plurality of slots.

23. The microwave introduction apparatus according to claim 22, wherein each of the plurality of slots has an arc shape.

24. The microwave introduction apparatus according to claim 22, wherein the antenna part has a ceiling plate formed of a dielectric material through which the microwave radiated from the antenna is transmitted and a wave retardation member for shortening wavelength of the microwave reaching the antenna, the wave retardation member being provided at an opposite side of the ceiling plate with respect to the antenna.

25. The microwave introduction apparatus according to claim 24, wherein the phase of a microwave is adjusted by adjusting the thickness of the wave retardation member.
